(19) United States
(12) Patent Application Publication
(10) Pub. No.: US 2009/0327303 A1
(43) Pub. Date: Dec. 31, 2009

(54) INTELLIGENT ALLOCATION OF FILE SERVER RESOURCES

(75) Inventors: TOM OOTJERS, KIRKLAND, WA (US); JEFFREY C. FULLER, REDMOND, WA (US); RAMANATHAN GANAPATHY, BOTHELL, WA (US); DAVID M. KRUSE, KIRKLAND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/163,427

(22) Filed: Jun. 27, 2008

(51) Int. Cl. G06F 17/30; G06F 15/173

(52) U.S. Cl. 707/10; 709/226; 707/E17.01; 707/E17.032

(57) ABSTRACT

A solution provides an efficient process for a user to complete operations within a file server system. A user's future requests, such as reading or writing files, are predicted based on previous operations. An effective amount of a file server's resources are allocated to accommodate the predicted future requests, thereby reducing the amount of required system time for performing operations corresponding to a file server memory.

### SUMMARY

Embodiments of the invention are defined by the claims below, not this summary. A high-level overview of embodiments of the invention are provided here for that reason, to provide an overview of the disclosure.

In a first aspect, a set of computer-useable instructions provides a method of allocating file server resources. A user initiates an operation, which causes the user's client computing device to communicate requests to a file server. The file server identifies the type of operation being initiated by monitoring the requests and allocates file server resources accordingly.

In a second aspect, a set of computer-useable instructions provides an exemplary method of allocating file cache buffer resources for uploading a file from a client computing device. An illustrative step includes receiving a preliminary input/output (I/O) request that indicates that the client is initiating a write operation. A file cache buffer is allocated and prepared for receiving data directly from the client. After the file cache buffer is allocated, a write request is received and the data is written directly into the file cache buffer that was prepared.

In another aspect, a set of computer-useable instructions provides an illustrative method of allocating read queue resources for downloading a file to a client computing device. An indication that a user associated with the client device is initiating a download operation is received. The file associated with the resource allocation is identified and a read queue is allocated and prepared such that read data can be received directly into the read queue.

In a fourth exemplary aspect, a set of computer-useable instructions provides an illustrative method for allocating a directory queue for receiving pre-fetched directory information such as metadata. An indication is received that a user is initiating a directory browse operation. The particular directory is identified and a portion of a directory queue is allocated and prepared for receiving metadata from the directory. A directory browse request is received and a portion of the directory is enumerated within the prepared directory queue.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a block diagram of an exemplary computing environment suitable for implementation of an embodiment of the present invention;

FIG. 2 is a block diagram of an exemplary networking environment suitable for implementation of an embodiment of the present invention;

FIG. 3 is a block diagram illustrating components of an exemplary file server in accordance with an embodiment of the present invention;

FIG. 4 is a schematic diagram illustrating an exemplary file upload operation in accordance with an embodiment of the present invention;

FIG. 5 is a schematic diagram illustrating an exemplary file download operation in accordance with an embodiment of the present invention;

FIG. 6 is a schematic diagram illustrating an exemplary directory browse operation in accordance with an embodiment of the present invention;

FIG. 7 is a flow diagram that shows an illustrative method of allocating file server resources in accordance with an embodiment of the present invention;

FIG. 8 is a flow diagram that shows another illustrative method of allocating file server resources in accordance with an embodiment of the present invention;

FIG. 9 is a flow diagram that shows an illustrative method of allocating file cache buffer resources in accordance with an embodiment of the present invention;

FIG. 10 is a flow diagram that shows an illustrative method of processing a file upload request in accordance with an embodiment of the present invention;

FIG. 11 is a flow diagram that shows an illustrative method of allocating read queue resources in accordance with an embodiment of the present invention; and

FIG. 12 is a flow diagram that shows an illustrative method of allocating directory queue resources in accordance with an embodiment of the present invention.

### DETAILED DESCRIPTION

Embodiments of the present invention provide systems and methods for allocating file server resources for predicted operations based on previously monitored network traffic.

Throughout the description of the present invention, several acronyms and shorthand notations are used to aid the understanding of certain concepts pertaining to the associated system and services. These acronyms and shorthand notations are intended to help provide an easy methodology of communicating the ideas expressed herein and are not meant to limit the scope of the present invention. The following is a list of these acronyms:
CIFS Common Internet File System
DFS Distributed File System
FAT File Allocation Table
FTP File Transfer Protocol
I/O Input/Output
LAN Local Area Network
MN Mobile Network
NFS Network File System (protocol)
NTFS New Technology File System
RAM Random Access Memory
SAI SetAllocationInformation Request
SEF SetEndOfFile Request
SMB Server Message Block

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, and the like. The invention may also be practiced in distributed computing environments where tasks are performed by remote-processing devices that are linked through a communications network.

Computer-readable media include both volatile and nonvolatile media, removable and nonremovable media, and contemplates media readable by a database, a server, and various other network devices. By way of example, and not limitation, computer-readable media comprise media implemented in any method or technology for storing information. Examples of stored information include computer-useable instructions, data structures, program modules, and other data representations. Media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

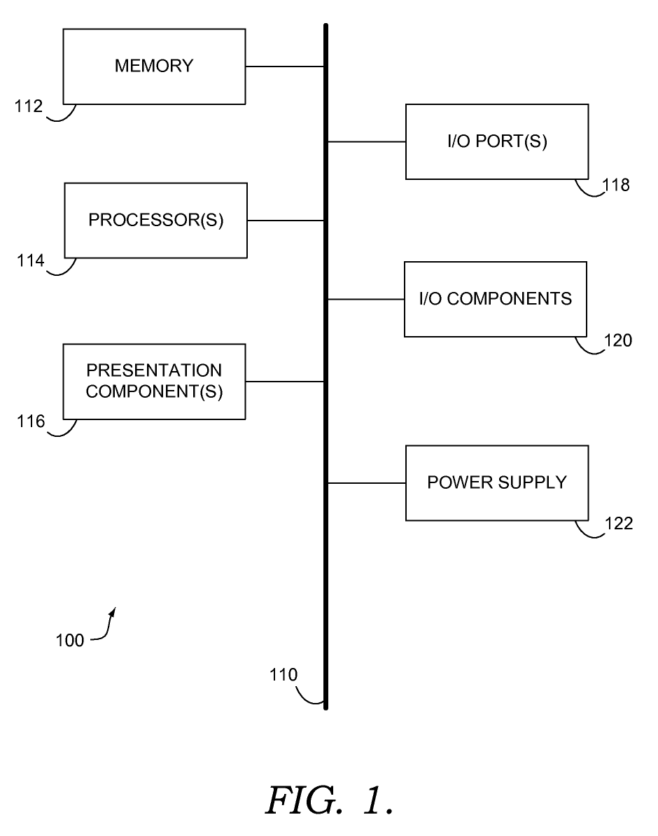

An exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Computing device 100 includes a bus 110 that directly or indirectly couples the following devices: memory 112, one or more processors 114, one or more presentation components 116, I/O ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including 1/0 components 120, some of which may be built in. Illustrative components include a microphone, joystick, game pad, satellite dish, scanner, printer, wireless device, keyboard, pen, voice input device, touch input device, touch-screen device, interactive display device, or a mouse.

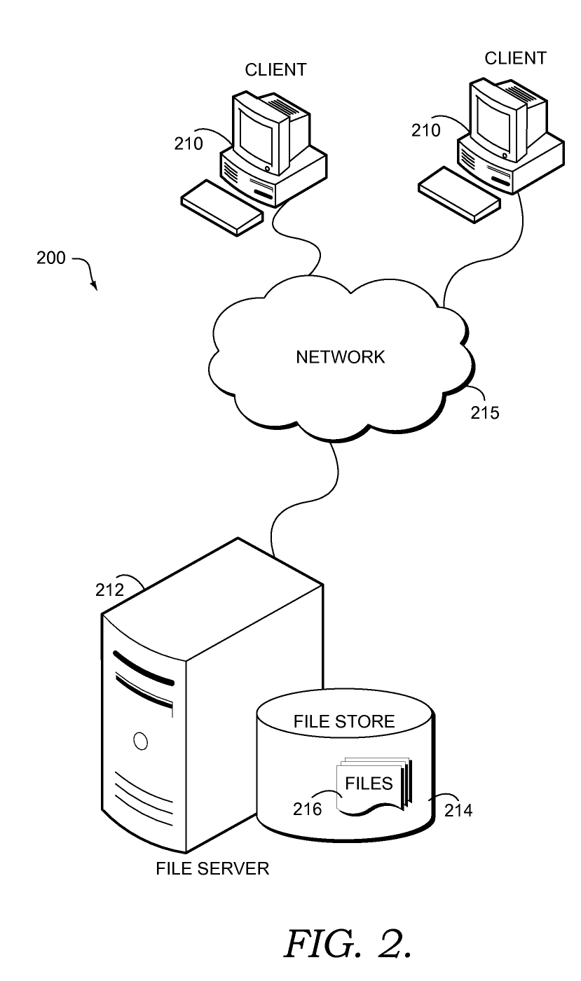

Turning to FIG. 2, an exemplary networking environment 200 for implementing an embodiment of the present invention is shown. Networking environment 200 includes client devices 210 and a file server 212 that communicates with client devices 210 via a network 215. Network 215 can be a local area network (LAN), a wide area network (WAN), a mobile network (MN), or any other type of network capable of hosting clients 210 and file server 212. Networking environment 200 is merely an example of one suitable networking environment and is not intended to suggest any limitation as to the scope of use or functionality of the present invention. Neither should networking environment 200 be interpreted as having any dependency or requirement related to any single component or combination of components illustrated therein.

Clients 210 include computing devices such as, for example, the exemplary computing device 100 described above with reference to FIG. 1. In an embodiment, clients 210 can communicate with each other directly or through network 215. Additionally, clients 210 can communicate with file server 212 through network 215. It should be understood that, although FIG. 2 illustrates a single network 215, in various embodiments of the present invention, clients 210 may actually communicate with each other or with file server 212 by way of a series of networks. For example, a client may access a WAN via a LAN or an MN. Network 215 is intended to represent all of these combinations and is not intended to limit the configuration of various networked communications in accordance with embodiments of the present invention.

File server 212 includes a server that provides storage for files, shared files and other data. As used herein, files can include data files, documents, pictures, images, databases, movies, audio files, video files, and the like. File server 212 can also manage access permissions and rights to stored files. In an embodiment, file server 212 is a dedicated file server. In another embodiment, file server 212 is a non-dedicated file server, and in further embodiments, file server 212 can be integrated with a client 210 or other computing device. File server 212 can include an internet file server, particularly where network 215 is the internet or other wide area network (WAN). In some embodiments, where network 215 is a local area network (LAN), file server 212 can be accessed using File Transfer Protocol (FTP). In other embodiments, file server 212 can be accessed using other protocols such as, for example, Hyper Text Transfer Protocol (HTTP) or Server Message Block (SMB) protocol. In a further embodiment, file server 212 can include a distributed file system such as the Distributed File System (DFS) technologies available from Microsoft Corporation of Redmond, Wash.

As further illustrated in FIG. 2, file server 212 includes a file store 214 on which reside files 216. In one embodiment, files 216 are written to file store 214 by client 210 in accordance with various aspects of the present invention. In an embodiment, files 216 are available to particular clients 210. In some embodiments, files 216 are shared among several clients 210, and in other embodiments, files 216 are only accessible by one of clients 210. Additionally, files 216 may be protected by various forms of security. For example, in one embodiment, files 216 have associated access control lists (ACLs) that include permission settings for a number of users. In another embodiment, file server 212 stores files 216 in an encrypted format. In other embodiments, file server 212 manages access to files 216 using other security technologies.

Each of these elements of the networking environment 200 is also scalable. That is, for example, file server 212 can actually include a number of file servers, operating in parallel with a load balancer such that large amounts of traffic may be managed. In some embodiments, file server 212 includes other servers that provide various types of services and functionality. File server 212 can be implemented using any number of server modules, devices, machines, and the like. In some embodiments, there is only one client 210, whereas in other embodiments, there are several clients 210. In a further embodiment, there are a large number of clients 210. Nothing illustrated in FIG. 2 or described herein is intended to limit the number of elements in a network suitable for implementation of various embodiments of the present invention.

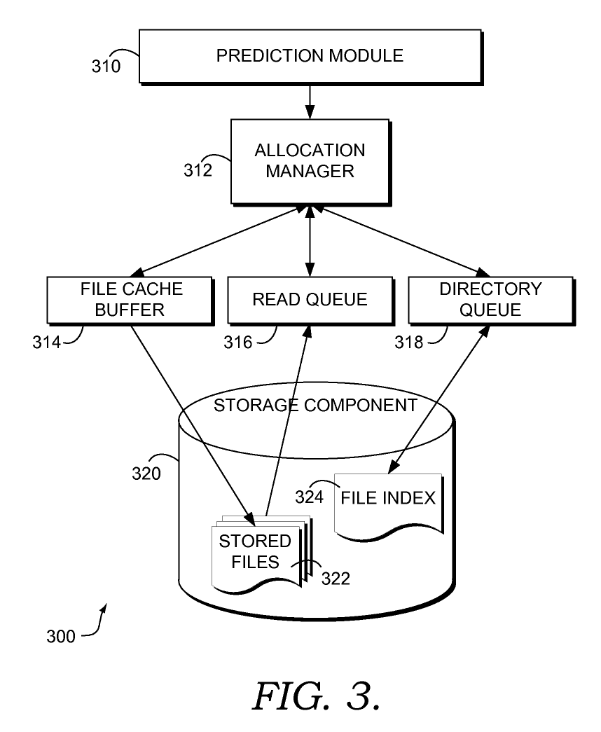

Turning now to FIG. 3, a block diagram is shown illustrating several components of an exemplary file server 300 in accordance with an embodiment of the present invention. In addition to other modules and components not illustrated in FIG. 3, file server 300 includes a prediction module 310, an allocation manager 312, a file cache buffer 314, a read queue 316, a directory queue 318, and a storage component 320. As illustrated in FIG. 3, storage component 320 includes stored files 322 and a file index 324. In an embodiment, storage component 320 is a database configured for storing files 322. In another embodiment, storage component 320 includes a physical storage device such as a disk.

According to embodiments of the present invention, storage component 320 includes a file system that facilitates the maintenance and organization of stored files 322. Nothing in this description is intended to limit the type of file system utilized in embodiments of the present invention, however examples of such file systems include the file allocation table (FAT) file system, the New Technology File System (NTFS), and the Distributed File System (DFS), each of which is available in various products from Microsoft Corporation of Redmond, Wash.

As illustrated in FIG. 3, storage component 320 also includes a file index 324. File index 324 can include various types of data or metadata corresponding to stored files 322. In an embodiment, file index 324 includes metadata that can be used to generate a directory associated with a file system. In various embodiments, file index 324 can facilitate location of stored files 322, tracking of modifications to stored files 322, and the like. In some embodiments, file server 300 includes file sharing functionality that allows users to share stored files 322 based on various attributes and access permissions that can be assigned to stored files 322. File index 324 can include metadata or other types of data that reflect the nature and configuration of such attributes.

With continued reference to FIG. 3, prediction module 310 provides information to allocation manager 312 to facilitate optimization of various operations performed by file server 300. In an embodiment, prediction module 310 includes processes and/or program modules that monitor I/O requests from clients. Prediction module 310 analyzes the monitored I/O requests to determine the types of operations associated with the I/O requests. In an embodiment, such I/O requests can correspond to operations such as, for example, file uploads (e.g., file writes), file downloads (e.g., file reads), enumeration of directories, downloads of multiple files, and the like. Various embodiments can use different protocols for communicating I/O requests and responses such as, for example, the Server Message Block (SMB) protocol, the Common Internet File System (CIFS) protocol, or the Network File System (NFS) protocol.

To perform operations such as these, clients communicate I/O requests that include syntax that file server 300 recognizes. File server 300 performs operations in response to the recognized syntax. Examples of I/O requests include write requests, read requests, disk allocation requests, and the like. I/O requests can also include preliminary communications that typically occur before write requests, read requests, and the like. For example, I/O requests may instruct file server 300 to allocate a particular amount of space on a disk for writing files. For example, I/O requests can include SetEndOfFile requests and SetFileAllocationInformation requests. In other examples, I/O requests can instruct file server 300 to read ahead files, data, or metadata into read queue 316 or directory queue 318 so that the files or data are available immediately when the client communicates a read request.

The syntax associated with I/O requests can be recognized by prediction module 310, which determines the type of operation a user is attempting to initiate by causing the client to communicate the I/O requests. For example, when a SetEndOfFile request is received from a client, a disk manager or file system manager may allocate a portion of disk memory for storing the file. In addition, the SetEndOfFile request can also be received by prediction module 310, which recognizes, based on the type of request, that the client is initiating an upload sequence. Other information provided simultaneously with or subsequent to the SetEndOfFile request can be used by the prediction module 310 to identify the file and/or other data that will be operated on during the operation.

As illustrated in FIG. 3, prediction module 310 provides information to allocation manager 312 identifying the type of operation associated with an I/O request, as well as the files or data that will be the subject of the operation. Allocation manager 312, according to one embodiment, is part of a cache manager. In another embodiment allocation manager 312 operates independently of a cache manager. Allocation manager 312 facilitates efficient allocation of file server resources for optimizing the performance of various types of tasks.

In an embodiment, allocation manager 312 allocates file cache buffers 314 in response to receiving preliminary I/O requests corresponding to upload operations. While cache managers may allocate disk space or file cache buffers 314 (e.g., virtual disk space, an mdl, etc.) incident to receiving a write request, allocation manager 312 allocates file cache buffers in response to receiving I/O requests that are preliminary to a write request. Preliminary requests can include, for example, SetEndOfFile requests and SetAllocationInformation requests. Once the write request is received, the data can be written directly into the allocated file cache buffer 314. This functionality allows for optimization of data buffering by receiving data into a buffer 314 in one step and then lazily writing the data to disk 320 in a next step rather than waiting for the write request to be received and storing the data in an intermediate buffer while allocating a file cache buffer 314 into which the data is later copied. Consequently, the amount of time that file server 300 is engaged in copying data between buffers is reduced, which improves responsiveness and throughput.

According to another embodiment of the present invention, allocation manager 312 allocates read queue 316 incident to receiving I/O requests corresponding to download operations from a client. Read queue 316 can include an asynchronous work item queue, a buffer, a cache, virtual memory, or some other portion of memory (i.e., RAM) in which data can be maintained in preparation for a read request. Although read queues may be populated with data by cache managers, disk managers, and the like, this typically only occurs in response to an actual read request or a pattern of read requests. In an embodiment of the present invention, allocation manager 312 allocates read queue 316 in response to preliminary I/O requests that are received prior to receiving read requests. Accordingly, when a read request is received in the present invention, the requested data can be read directly into read queue 316, which has already been prepared by allocation manager 312.

In a further embodiment, allocation manager 312 allocates directory queue 318. Directory queue 318 can include an asynchronous work item queue, a buffer, a cache, virtual memory, or some other portion of memory (i.e., RAM) in which data and/or metadata can be maintained in preparation for enumerating a directory for browsing by a user. In an embodiment, allocation manager 312 allocates and prepares directory queue 318 in response to preliminary I/O requests received prior to receiving a directory browse request. Then, when a request is received for browsing a directory, allocation manager 312 can populate directory queue 318 with data or metadata from the file index 324 and the client can read the directory directly from directory queue 318.

Although several specific embodiments of allocation manager 312 are described in detail above, the descriptions herein are not intended to limit the functions that allocation manager 312 can perform to only those described in detail herein. Allocation manager 312 can be configured to allocate any number of types of file server resources so that when operation requests are received, the operations can be performed without intermediate caching or buffering.

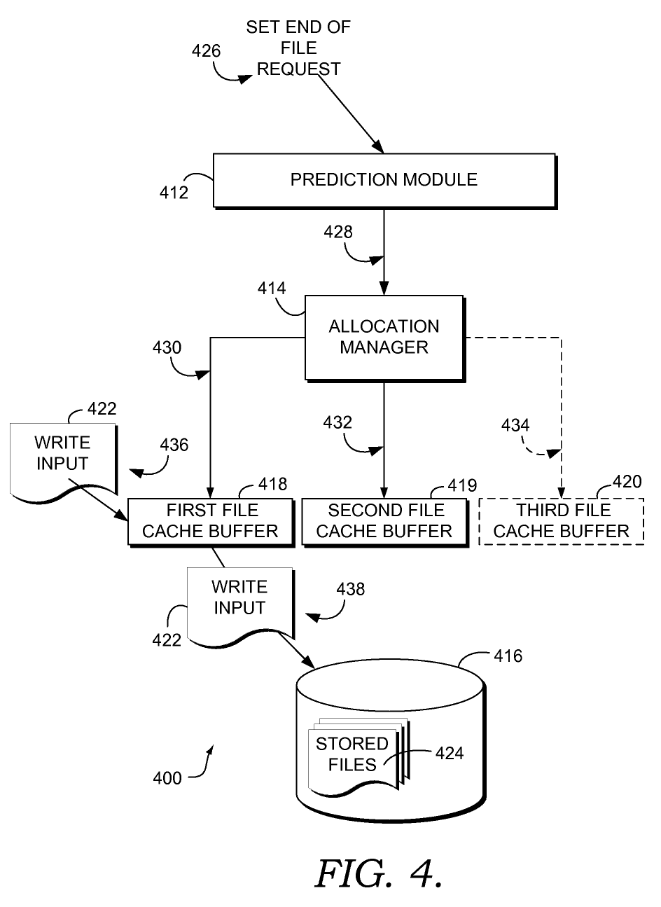

Turning now to FIG. 4, a schematic diagram is shown illustrating an exemplary file upload operation 400 in accordance with an embodiment of the present invention. As illustrated in FIG. 4, a SetEndOfFile request 426 is received by prediction module 412. As explained above with reference to FIG. 3, the request received need not necessarily be a SetEndOfFile request, but can, in some embodiments, be any other type of request that prediction module 412 can recognize as being associated with a file upload operation. Prediction module 412 examines the request 426 and determines that a user is initiating a file upload operation. Prediction module 412 provides this information, which includes an indication that the user is initiating an upload operation with respect to a particular file of a particular size, to allocation manager 414, as shown at 428.

Allocation manager 414, incident to receiving the indication that an upload operation is being initiated, allocates, as shown at 430, a first file cache buffer 418, preparing the first file cache buffer 418 for receiving data. Additionally, if the file to be uploaded is larger than the capacity of the first file cache buffer 418, allocation manager 414 allocates, as shown at 432, a second file cache buffer 419. As indicated at 436 in FIG. 4, write input 422 is received, accompanied by a write request (not shown) that causes write input 422 to be written to the first file cache buffer 418. After the first file cache buffer 418 is full, the user writes data to the second file cache buffer 419.

Depending on the size of the file to be uploaded, allocation manager 414 may allocate a third file cache buffer 420, as indicated at 434. In an embodiment, the third file cache buffer 420 is allocated before write data 422 is received. In another embodiment, the third file cache buffer 420 is allocated after the first file cache buffer is full. In other embodiments, the third file cache buffer 420 is allocated only when necessary, which may be determined by allocation manager 414 at any point in the process illustrated in FIG. 4. After the write operation is completed—that is, after the entire file is written into file cache buffers 418, 419, and 420—the write input 422 is lazily copied to a disk 416, which maintains stored files 424.

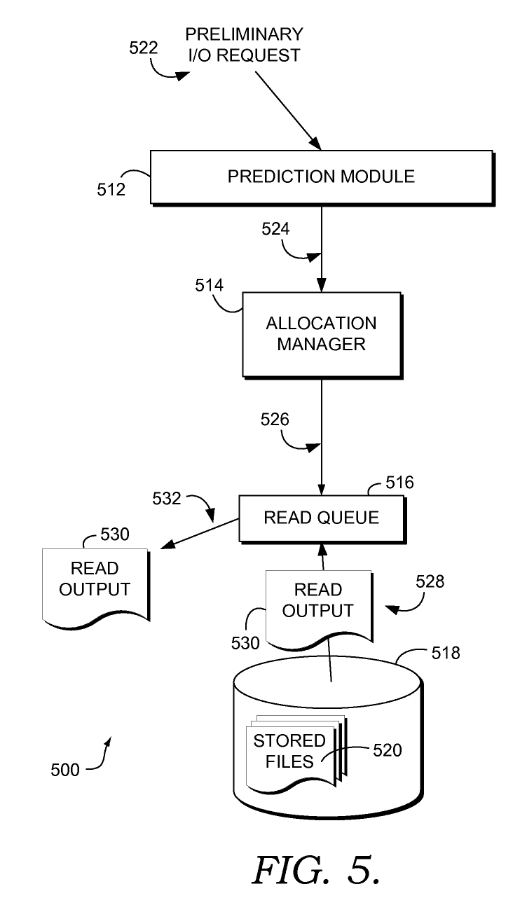

Turning now to FIG. 5, a schematic diagram is shown that illustrates an exemplary file download operation 500 in accordance with an embodiment of the present invention. As illustrated, a preliminary I/O request 522 is received by prediction module 512. The preliminary I/O request 552 indicates to prediction module 512 that a user is initiating a read operation with respect to a stored file or files 520 residing on a disk 518 associated with the file server. In various embodiments, the preliminary I/O request 552 is a request or sequence of requests that are specific to the application requesting the read operation. One common sequence, for example, is to query for stream information, then query for extended attributes (EA) information, and then perform the read request. In an embodiment, preliminary I/O request 552 includes a query for stream information. In another embodiment, for example, preliminary I/O request 552 includes a query for EA. In still a further embodiment, preliminary I/O request 552 includes some combination of both queries.

Prediction module 512 recognizes, based on preliminary I/O request 522, that the user is initiating a read operation with respect to a particular stored file 520. Prediction module 512 provides allocation manager 514 with an indication, as shown at 524, that the user is initiating a read operation with respect to the stored file 520. Allocation manager 514 can, in an embodiment, determine the size of the stored file 520 and allocate resources accordingly. As illustrated at 526 in FIG. 5, allocation manager 514 allocates a read queue 516 incident to receiving that indication, and prepares the read queue 516 for receiving read output 530. Read output 530 is read into the read queue 516, as shown at 528. Read output 530 can then be read directly from the read queue 516 by the client, as shown at 532.

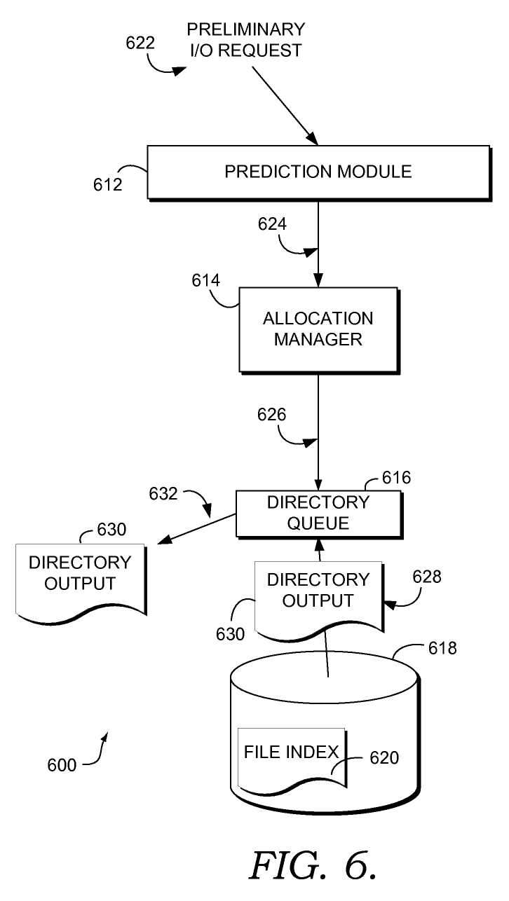

With reference to FIG. 6, a schematic diagram is shown that illustrates an exemplary directory browse operation 600 in accordance with an embodiment of the present invention. A preliminary I/O request 622 is received by prediction module 612, which interprets preliminary 1/0 request 622 as an indication that a user has initiated a directory browse operation. For example, in an embodiment, preliminary I/O request 622 can include a previous directory browse request.

As illustrated at 624, prediction module 612 provides information corresponding to that indication to allocation manager 614. Incident to receiving the indication that the user has initiated a directory browse operation, allocation manager 614 allocates, as shown at 626, a directory queue 616 and prepares the directory queue 616 for receiving an enumerated directory based on metada included in a file index 620 maintained on a disk 618. Responsive to a directory browse request (not shown), directory output 630 is read into the directory queue 616, as indicated at 628. The directory output 630 can then be accessed directly, as shown at 632, by a client, which reads the directory output 630 from the directory queue 616.

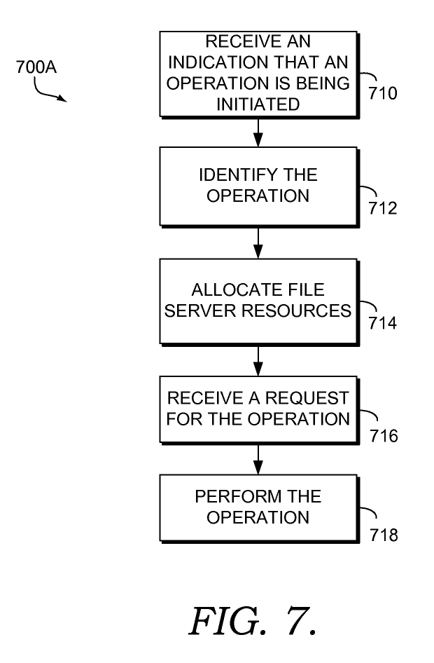

To recapitulate, we have described systems and methods for allocating file server resources in response to predicting operations requested by users based on previous network traffic data (e.g., preliminary I/O requests). Turning now to FIG. 7, a flow diagram is provided, which shows an illustrative method 700A of allocating file server resources in accordance with an embodiment of the present invention. At an illustrative step 710, a preliminary request is received from a client computing device that indicates that an operation is being initiated by a user of the client computing device. In an embodiment, the operation includes a file upload, which may also be referred to as a file write. In another embodiment, the operation includes a file download, which may also be referred to as a file read. In yet another embodiment, the operation includes browsing a directory, which may be referred to herein as a directory browse.

Additionally, according to one embodiment, the preliminary request includes a single request that is operable to initiate an operation. In another embodiment, the preliminary request includes a number of requests associated with initialization of an operation. In still a further embodiment, the request includes one of a number of requests associated with initialization of an operation. It should be understood that, although this communication is referred to as a request herein, the request can include, in various embodiments, a command, an instruction, or any other type of communication from a client computing device that corresponds to initiation of an operation on a file server.

At step 712, the operation is identified based on the preliminary request. In an embodiment, the operation comprises a data transfer that utilizes file server resources. Each of the exemplary operations described above can be characterized as a data transfer operation, as each one of the operations includes a transfer of file data or directory data between a client computing device and a file server. In other embodiments, further operations that involve data transfer between a client computing device and a file server can also be included within the ambit of the illustrative methods described herein, so long as the operation involves the use of file server resources. For example, the operation can include modifying a file, modifying an attribute associated with a file, returning query results, and the like.

With continued reference to FIG. 7, at step 714, appropriate file server resources are allocated for use in the identified operation. Accordingly, when the file server performs the operation, the necessary resources for completing the task are already prepared for use. In an embodiment, file server resources include buffers such as file cache buffers, disk buffers, and the like. In another embodiment, file server resources include queues for maintaining work items. In still a further embodiment, file server resources include virtual memory. In various embodiments, the resources include pageable memory, while in other embodiments, the resources include non-pageable memory. Other file server resources capable of being allocated according to aspects of the illustrative methods described herein are intended to be included within the ambit of the present invention.

At step 716, a request for the operation is received from the client. In an embodiment, the request for the operation is a write request. In another embodiment, the request for the operation is a read request. In still a further embodiment, the request for the operation is a directory browse request. In a final illustrative step 718, the file server performs the operation. As indicated above, performing the operation includes, in various embodiments, causing data to be transferred to a client computing device. In other embodiments, performing the operation includes receiving data transferred from a client computing device. In still further embodiments, performing the operation can include manipulating data maintained on the file server, copying files maintained on the file server, providing content for display on a display device associated with the client computing device, or a number of other operations.

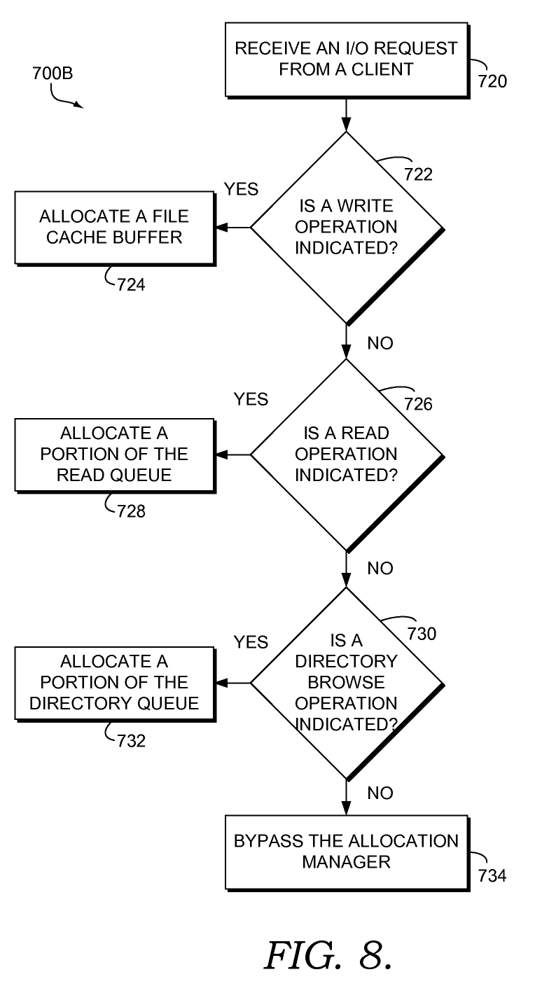

Turning to FIG. 8, a flow diagram is provided, which shows another illustrative method 700B of allocating file server resources in accordance with an embodiment of the present invention. At a first illustrative step, 720, an I/O request is received from a client computing device. At step 722, a determination is made as to whether the I/O request indicates a write operation. If the I/O request indicates a write operation, a file cache buffer is allocated, as illustrated at step 724. If not, a determination is made whether the I/O request indicates a read operation, as shown at step 726. If the I/O request indicates a read operation, a portion of the read queue is allocated at step 728. If not, a determination is made whether the I/O request indicates a directory browse operation, as shown at step 730. If so, a portion of the directory queue is allocated at step 732. If the I/O request does not indicate a directory browse, the I/O request bypasses the allocation manager, as shown at step 734, and can be provided to the appropriate service or program module.

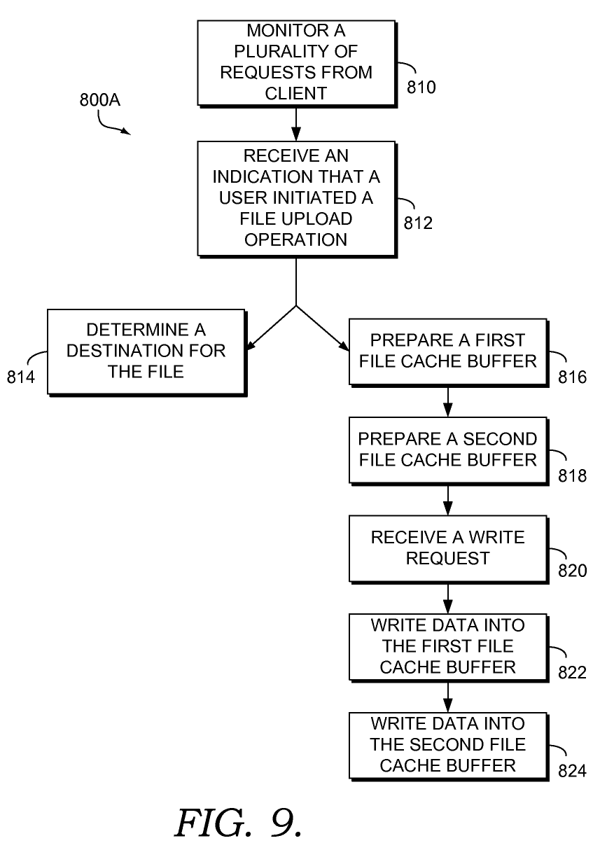

Turning to FIG. 9, a flow diagram is provided, which shows an illustrative method 800A of allocating file cache buffer resources for uploading a file from a client computing device in accordance with an embodiment of the present invention. As shown at step 810, a plurality of requests from the client are monitored by the file server. At step 812, an indication is received that indicates that a user associated with the client has initiated a file upload operation. The indication includes information associated with a request or requests monitored in step 810.

At step 814, a destination is determined for the file. In an embodiment, determining a destination for the file includes allocating space on a disk. At step 816, which may happen simultaneously to, or very close in time to step 814, a first file cache buffer is prepared. In an embodiment, the first file cache buffer is prepared by allocating a first portion of memory (e.g., RAM) associated with the first file cache buffer. In various embodiments of the invention, the first file cache buffer is prepared before a write request is received, and is therefore ready to receive data directly from a write incident to receipt of a write request. At step 818, a second file cache buffer is prepared.

In one embodiment, the second file cache buffer is prepared before any data is written into the first file cache buffer. In another embodiment, the second file cache buffer is prepared only after the first file cache buffer begins to fill up with data. In various embodiments, the second file cache buffer is prepared before the first file cache buffer is full, allowing a seamless transition from writing data into the first file cache buffer to writing data into the second file cache buffer. At step 820, a write request is received from the client and, incident to receiving the write request, data is written directly into the first file cache buffer, as shown at step 822. When the first file cache buffer is full, data is written into the second file cache buffer, as shown at a final illustrative step 824.

Because data is written into the first file cache buffer directly, an intermediate cache or buffer such as, for example, a receiving buffer, a network buffer, an output cache or an input cache, is not necessary. Accordingly, this process also does not require copying the data from an intermediate buffer into the file cache buffer.

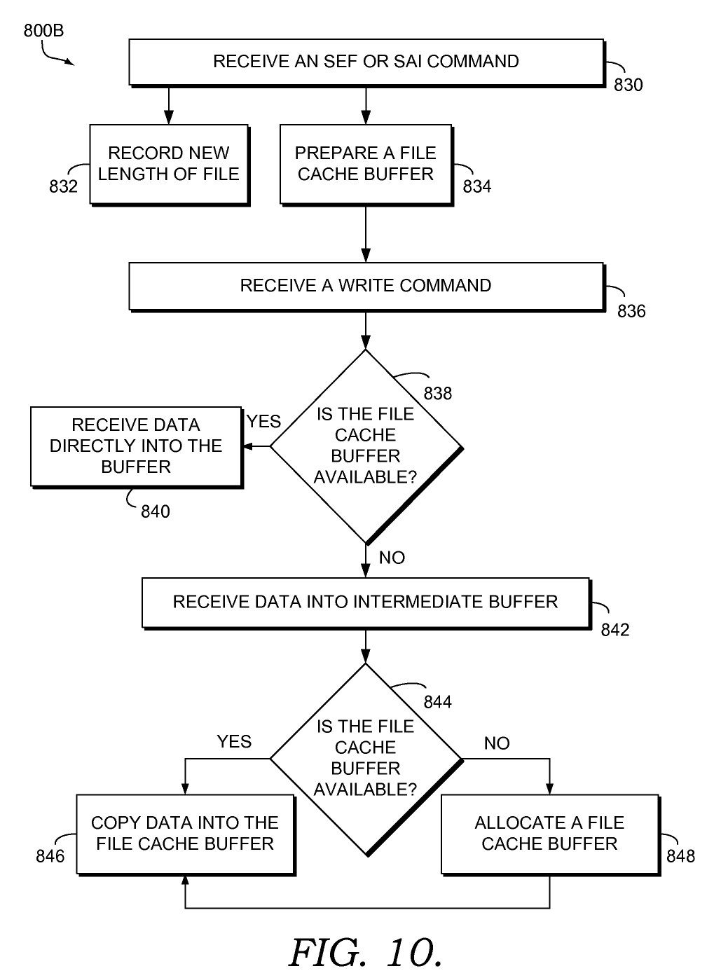

Turning now to FIG. 10, a flow diagram is provided, which shows an illustrative method 800B of processing a file upload request in accordance with an embodiment of the present invention. At a first illustrative step 830, a SetEndOfFile (SEF) or a SetAllocationInformation (SAI) request is received. At step 832, the new length of the file is recorded and at step 834, a file cache buffer is prepared. In an embodiment, steps 832 and 834 are performed simultaneously, or as nearly to simultaneously as possible. As illustrated at step 836, a write command is received from the client. At step 838, a determination is made whether the file cache buffer is available to receive data. If the file cache buffer is available, data is received directly into the file cache buffer, as shown at step 840. If the file cache buffer is not available, data is received into an intermediate buffer 842.

As shown at step 844, a second determination is made whether the file cache buffer is available. If the file cache buffer is available, the data is copied from the intermediate buffer into the file cache buffer, as shown at step 846. If the file cache buffer is not available, a file cache buffer must first be allocated, as shown at step 848, before the data is copied into the file cache buffer at step 846.

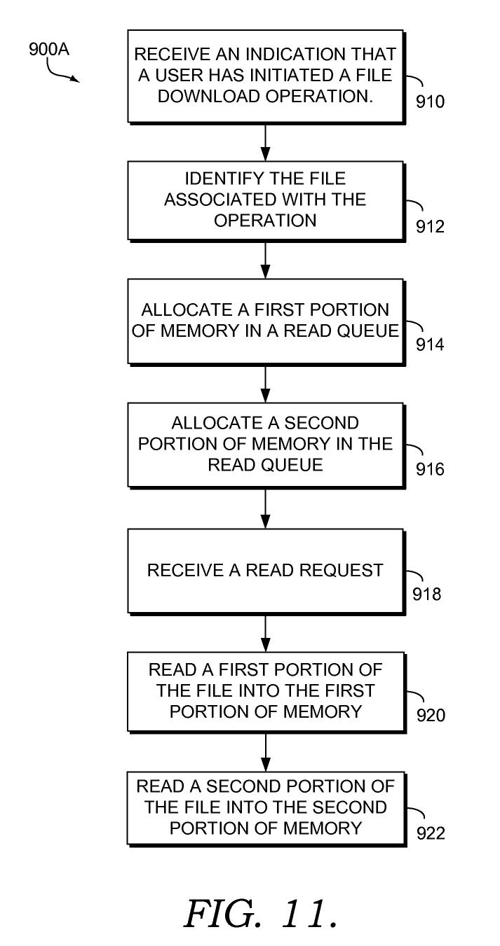

Turning now to FIG. 11, another flow diagram is provided, which shows an illustrative method 900A of allocating read queue resources for downloading a file to a client computing device from a file server in accordance with an embodiment of the present invention. At a first illustrative step 910, an indication that a user has initiated a file download operation is received. In an embodiment, the indication may include, or be derived from, a number of I/O requests from the client. At step 912, the file associated with the operation is identified and at step 914, a first portion of memory in a read queue is allocated. In an embodiment, a read queue may include a disk queue, a cache, virtual memory space, a buffer, or the like. The first portion of memory in the read queue can be allocated by preparing it to receive data based on the length of the file.

Similarly, at step 916, a second portion of memory in the read queue is allocated. As shown at step 918, a read request is received from the client. Incident to receiving the read request, as shown at step 920, a first portion of the file is read into the first portion of memory such that the first portion of the file can be provided directly to the client device. At a final illustrative step 922, a second portion of the file is read into the second portion of memory after the first portion of memory is full. In some embodiments, all of the read data may fit within the first portion of memory. In that case, it would not be necessary to write into a second buffer,.

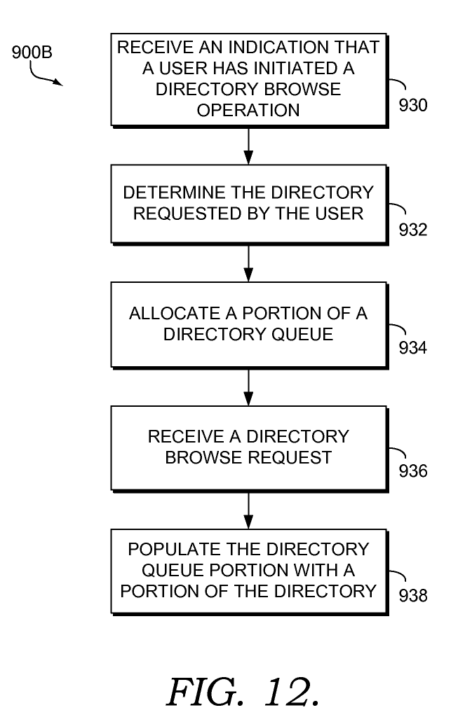

With reference now to FIG. 12, a flow diagram is provided, which shows an illustrative method 900B of allocating directory queue resources in accordance with an embodiment of the present invention. At step 930, an indication that a user has initiated a directory browse operation is received and, as shown at step 932, the directory requested by the user is determined. At step 934, a portion of a directory queue is allocated. At step 936, a directory browse request is received and consequently, the directory queue portion is populated with a portion of the directory, as shown at a final illustrative step 938. The client can browse the directory by reading the directory data directly from the directory queue.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

For example, in one embodiment, a file server may include several allocation managers, each configured to allocate one type of resource. In another embodiment, a file server may be implemented that includes a single allocation manager that is configured to allocate each type of resource available. In further embodiments, various combinations of file server resources may be handled by an allocation manager, while other combinations of resources may be handled by an additional allocation manager.

Further, in an embodiment, the amount of file cache memory that can be used in accordance with this invention can be limited to prevent denial of service attacks. In one embodiment, the memory is limited at a global level and in other embodiments, the memory can be limited on a per-connection or per-file level. In still a further embodiment, denial of service attacks can be prevented by releasing buffers that have not been written to within a specified amount of time.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-storage media having computer-executable instructions embodied thereon for performing a method of allocating file server resources, the method comprising:
receiving a preliminary I/O request from a client computing device, the request corresponding to an operation initiated by a user of the client;
identifying the operation based on the request, wherein said operation comprises a data transfer that uses one or more file server resources;
allocating at least one of the one or more file server resources; and
performing the data transfer.

2. The media of claim 1, wherein said operation comprises browsing a directory of files stored on the file server.

3. The media of claim 1, wherein said operation comprises downloading a file.

4. The media of claim 1, wherein said operation comprises uploading a file.

5. The media of claim 2, wherein said data transfer comprises providing a directory for display on the client device.

6. The media of claim 5, wherein the at least one allocated file server resource comprises a read queue.

7. One or more computer-storage media having computer-executable instructions embodied thereon for performing a method of allocating file cache buffer resources for uploading a file from a client computing device, the method comprising:
monitoring a plurality of requests from the client;
receiving an indication that a user has initiated a file upload operation using a client computing device, wherein said indication comprises a preliminary I/O request corresponding to a file upload operation;
determining a destination for the file, wherein said destination comprises a portion of storage space on a disk;
preparing the first file cache buffer for receiving data, wherein said first file cache buffer is prepared before a write request is received;
receiving a write request associated with the file; and
writing data corresponding to a first portion of the file into the first file cache buffer.

8. The media of claim 7, wherein said indication comprises information associated with at least one of the plurality of requests.

9. The media of claim 7, wherein preparing the first file cache buffer comprises allocating a first portion of memory associated with the first file cache buffer.

10. The media of claim 7, wherein writing data corresponding to the first portion of the file into the first file cache buffer comprises writing the data directly into the first file cache buffer without performing an intermediate cache.

11. The media of claim 9, further comprising preparing a second file cache buffer for receiving data.

12. The media of claim 10, wherein the second file cache buffer is prepared before the first file cache buffer is full.

13. The media of claim 12, further comprising writing data corresponding to the file into the second file cache buffer when the first file cache buffer is full.

14. One or more computer-storage media having computer-executable instructions embodied thereon for performing a method of allocating read queue resources for downloading a file to a client computing device, the method comprising:
receiving an indication that a user has initiated a file download operation using a client computing device;
identifying the file associated with the operation based on the indication;
preparing a read queue for receiving read output, wherein said preparing is based on one or more attributes associated with the file;
receiving a read request, wherein the read request is received after the read queue has been prepared; and
reading a first portion of the file into the read queue such that the first portion of the file can be provided directly to the client device.

15. The media of claim 14, wherein said indication comprises a plurality of requests communicated from the client.

16. The media of claim 14, wherein preparing a read queue comprises allocating a first portion of memory associated with the read queue.

17. The media of claim 16, further comprising allocating a second portion of memory associated with the read queue.

18. The media of claim 17, wherein said second portion of memory is allocated before the first portion of memory is full.

19. The media of claim 18, further comprising reading the second portion of the file into the second portion of memory when the first portion of memory is full.

20. The media of claim 14, wherein at least one of the one or more attributes comprises a size of the file.
